(19) United States
(12) Patent Application Publication
(10) Pub. No.: US 2016/0100586 A1
(43) Pub. Date: Apr. 14, 2016

(54) MICROBIAL AGRICULTURE

(71) Applicant: DSM IP ASSETS B.V., Heerlen (NL)

(72) Inventors: Ruth Emelia Wilhelmina DONNERS, Echt (NL); Manoj KUMAR, Echt (NL)

(21) Appl. No.: 14/893,190

(22) PCT Filed: May 28, 2014
(86) PCT No.: PCT/EP2014/061028

§ 371 Date: Nov. 23, 2015

Related U.S. Application Data
(60) Provisional application No. 61/840,127, filed on Jun. 27, 2013.
(60) Provisional application No. 61/830,016, filed on May 31, 2013.

(51) Int. Cl. A01N 63/00; A01G 1/00

(52) U.S. Cl. CPC A01N 63/00; A01G 1/001

(57) ABSTRACT

The present invention relates to novel compositions for enhancing plant growth and crop yield. Moreover, the present invention is directed to the production of these compositions and the uses of these compositions.

### FIELD OF THE INVENTION

The present invention relates to novel compositions for controlling diseases mediated by fungal plant pathogens. More in particular, the compositions comprise natamycin producing bacterial strains.

### BACKGROUND OF THE INVENTION

It is well known that plants and farm crops are constantly plagued by a variety of pests which can damage their growth or even completely destroy them. Some of the pests are in the form of weeds which grow similarly to the desired plant and compete for the nutrients provided by the soil and water. Other pests are in the form of pathogens such as fungi and bacteria which are found in association with many plants.

To avoid or reduce economic losses due to the assault of fungal plant pathogens, synthetic chemical fungicides have been traditionally used to keep the development of diseases in check. For instance, to reduce yield losses due to fungal spoilage, a significant fraction of the seeds is currently treated with one or more synthetic agrochemicals. The use of synthetic agrochemicals to control fungal pathogens in seeds, however, has increased costs to farmers and has caused harmful effects on the ecosystem. Improperly used synthetic agrochemicals contaminate water, air and soil and have lasting harmful effects on aquatic life, birds, mammals, and beneficial insects such as bees.

Public attitude and environmental concerns towards the use of synthetic agrochemicals as well as the development of resistant fungi to different synthetic agrochemicals have reduced the appeal of these chemicals. Moreover, the number of synthetic agrochemicals that are registered is decreasing due to governmental restrictions in pesticide usage.

In addition, applying agrochemicals to seeds is fraught with problems such as bonding of the agrochemicals to the soil, agglomeration of the seeds due to the application of the agrochemicals and the use of expensive and complex chemical application equipment. Moreover, seeds can be adversely affected by agrochemicals, as these chemicals can be toxic to the seeds and to the plants that sprout from the seeds. Such toxicity limits the amount of these agrochemicals that can safely be applied to the seeds. One undesirable effect of the toxicity is the reduction of the germination rate, or even total lack of germination, of seeds that have been treated. All these constraints associated with the use of synthetic agrochemicals have led to the search of alternative methods to control fungal diseases of seeds.

The use of biological control agents such as living micro-organisms is gaining recognition as an alternative to control fungal diseases of seeds. US 2011/0257009 discloses methods for treating seeds with mixtures comprising synthetic agrochemicals and living micro-organisms. A disadvantage thereof is that still synthetic agrochemicals are part of the treatment which is undesirable.

The sole use of biological control agents to protect seeds from fungal pathogens has also been disclosed. For instance, in U.S. Pat. No. 6,280,722 the use of a Bacillus thuringiensis strain for treating seeds has been disclosed. In U.S. Pat. No. 5,496,547 the use of a Pseudomonas fluorescens strain for treatment of seeds has been disclosed, while in US 2011/0020286 seeds have been treated with a Trichoderma atroviride strain.

It has been observed that some biological control agents are effective in the laboratory only, but do not show their activity in the field. This may be due to difficulty in production of the agent, poor stability of the agent during storage prior to application, rapid degradation of the agent in the field and/or insufficient performance of the agent over a wide range of environmental conditions.

Ergo, there is a significant need for novel biological control agents that do not have the above-mentioned disadvantages and are capable of controlling fungal plant pathogens in the field and thus provide plants with a protected growth environment to enhance their growth and increase crop yield.

### SUMMARY OF THE INVENTION

A large part of the damage to crop plants which is caused by fungal plant pathogens occurs as early as when the seeds are attacked during storage, after the seeds are introduced into the soil, and during and immediately after germination of the seeds. This latter phase is particularly critical, since the roots and shoots of the growing plants are particularly sensitive and even minor damage can lead to deformation, poor growth, poor crop yield or to the death of the whole plant. It is therefore of particular interest to reduce the incidence of fungal infection of seeds, roots, shoots and seedlings. In accordance with the present invention, it has been discovered that natamycin producing bacterial strains can be used to control and inhibit fungal diseases of seeds, roots, shoots and seedlings. The natamycin producing bacterial strains are safe to both humans and the environment.

### DETAILED DESCRIPTION OF THE INVENTION

One aspect of the present invention relates to a method for enhancing plant growth, crop yield or both, the method comprising the step of applying at least one natamycin producing bacterial strain to a seed, a medium to be planted by the seed or both. By applying the natamycin producing bacterial strain to a seed, a medium to be planted by the seed or both, germination of the seed may be improved. Therefore, the present invention also pertains to a method for improving seed germination, the method comprising the step of applying at least one natamycin producing bacterial strain to a seed, a medium to be planted by the seed or both. As an example, the natamycin producing bacterial strain may improve the seed germination by 1 to 25%, after 14 to 16 days of incubation of the seeds at 20-30° C. An assay to measure seed germination can be found in the Handbook International Rules for Seed Testing, Edition 2011, Chapter 5, published by the International Seed Testing Association, Switzerland. In short, seeds are incubated in a professional germination room with set temperatures and light conditions. Seeds are planted in roll paper according to well-known ISTA (International Seed Testing Association) procedures (see Handbook International Rules for Seed Testing, Edition 2011, Chapter 5, published by the International Seed Testing Association, Switzerland). The planted seeds are subjected to the following cycle for 14 to 16 days: 12 hours dark at 20° C. followed by 12 hours of light at 30° C.; humidity is between 98 and 100%.

By applying the natamycin producing bacterial strain to a seed, a medium to be planted by the seed or both, a positive yield response in a plant growing from the seed may be obtained. Moreover, the quality of harvested plant materials may be improved by application of the natamycin producing bacterial strain to a seed, a medium to be planted by the seed or both, as the contents of mycotoxins in plants and/or harvested plant materials may be reduced.

Another aspect of the present invention is directed to a method for controlling a fungal disease in a plant, the method comprising the step of applying at least one natamycin producing bacterial strain to a seed, a medium to be planted by the seed or both. The natamycin producing bacterial strain is applied under conditions effective to treat plant diseases mediated by fungal plant pathogens and suppresses growth of fungal plant pathogens. The natamycin producing bacterial strain can be used to control a fungal disease in a plant within a certain time period after the application of the strain. The time period spans in general up to 300 days after treatment of seeds. It is applied in an effective amount, meaning an amount which is sufficient to control or even completely kill the fungal disease and at the same time does not exhibit symptoms of phytotoxicity. The amount to be applied may vary within a broad range and are dependent on many factors including, but not limited to, the type of fungal disease to be controlled, the plant to be treated, and the climatic conditions.

Preferably, the strain applied is living. The strain may be applied in any physiological state such as active or dormant. In an embodiment the strain is a spore-forming strain. The strain may be purified or non-purified. The strain may be applied as a biologically pure culture or inoculum. The term “natamycin producing bacterial strain” as used herein also includes spores or spore-like structures of natamycin producing bacteria. The spores or spore-like structures themselves may be capable of producing natamycin. Alternatively, the spores or spore-like structures may not be capable of producing natamycin, but can develop into natamycin producing bacterial strains once conditions are favorable.

In an embodiment the natamycin producing bacterial strain is selected from the group consisting of a Streptomyces natalensis strain, a Streptomyces gilvosporeus strain, a Streptomyces chattanoogensis strain, and a Streptomyces lydicus strain. Methods for producing natamycin producing bacterial strains are known in the art, for example in WO 93/03171, WO 93/03169, WO 2004/087934, Martin and McDaniel (1977), Chen et al. (2008), Farid et al. (2000), El-Enshasy et al. (2000b), He et al. (2002), and Liang et al. (2008). Streptomyces natalensis strains include, but are not limited to, the following strains: ATCC27448, BCRC 15150, CBS 668.72, CBS 700.57, CCRC 15150, CCTM La 2923, CECT 3322, CGMCC 100017, CGMCC 100019, DSM 40357, F ATCC27448, Hoogerheide strain KNGSF, IFO 13367, ISP 5357, JCM 4693, JCM 4795, KCC 693, KCC S-0693, KCC S-0795, KCCS-0693, KCCS-0795, KNGS strain F, NBRC 13367, NCIB 10038, NCIM 2933, NCIM 5058, NCIMB 10038, NRRL 2651, NRRL B-2651, NRRL B-5314, RIA 1328, RIA 976, VKM Ac-1175, VKM Ac-1175. Furthermore, the Streptomyces natalensis strains as described in the examples can be used in the present invention. In a preferred embodiment, Streptomyces natalensis strains are used in the present invention. In an even more preferred embodiment, the Streptomyces natalensis strains with the internal coding DS73870 and DS73871 are used in the present invention. The strains were deposited under the terms of the Budapest Treaty with the Centraal Bureau voor Schimmelcultures (CBS), Utrecht, Netherlands, on May 20, 2014. S. natalensis strain DS73870 has been deposited as strain CBS 137965. S. natalensis strain DS73871 has been deposited as strain CBS 137966.

Streptomyces gilvosporeus strains include, but are not limited to, the following strains: A-5283, ATCC13326, NRRL B-5623. Streptomyces chattanoogensis strains include, but are not limited to, the following strains: AS 4.1415, ATCC 13358, ATCC 19739, BCRC 13655, Burns J-23, CBS 447.68, CBS 477.68, CCRC 13655, CCTM La 2922, CECT 3321, CGMCC 100020, CGMCC 4.1415, CUB 136, DSM 40002, DSMZ 40002, Holtman J-23, IFO 12754, ISP 50002, ISP 5002, J-23, JCM 4299, JCM 4571, KCC S-0299, KCC S-0571, KCCS-0571, KCCS-0299, KCTC 1087, Lanoot R-8703, LMG 19339, NBRC 12754, NCIB 9809, NCIMB 9809, NRRL B-2255, NRRL-ISP 5002, R-8703, RIA 1019, VKM Ac-1775, VKM Ac-1775. Streptomyces lydicus strains include, but are not limited to, the following strains: CGMCC No. 1653.

To control fungal plant pathogens and thus to enhance plant growth and crop yield, seeds and plants may be cultivated within the effective area of the natamycin producing bacterial strain. In an embodiment the natamycin producing bacterial strain can be directly incorporated into the medium to be planted by the seed e.g. soil. Direct incorporation can be in the form of mixing the natamycin producing bacterial strain with the medium to be planted by the seed. The bacterial strain can be mixed in liquid form for instance as a suspension or emulsion with the medium or it can be mixed in dry form for instance as a granule, pellet or powder with the medium. The natamycin producing bacterial strain can be applied to the medium to be planted by the seed by for instance spraying, injection, dusting, sprinkling, irrigation or drenching. The natamycin producing bacterial strain is applied to the medium to be planted by the seed in an amount effective for controlling fungal diseases. The strain is effective when delivered at a concentration of 10³-10¹¹ colony forming units (cfu) per gram. For application in or on a medium to be planted by the seed from 0.1 to 10,000 g/ha can be used.

“A medium to be planted by the seed” as used herein means any growing environment suitable for growing a plant and/or seedling from a seed such as soil and other growth media (natural or artificial). The natamycin producing bacterial strain can be applied to for example the soil in-furrow, growing blocks, gutters or in T-bands. The natamycin producing bacterial strain can be applied to the medium to be planted by the seeds at the same time as the seeds are sown but it can also be applied before or after sowing. The medium to be planted by the seed may be present outdoors e.g. in the field, in greenhouses, in shadehouses, in growth chambers or in containers to name just a few.

In another embodiment the natamycin producing bacterial strain can be applied to the seed. Although the present method can be applied to seeds in any physiological state, it is preferred that the seeds be in a sufficiently durable state that they incur no significant damage during the seed treatment process. Typically, the seeds are seeds that have been harvested from the field; removed from the plant; and/or separated from the fruit and any cob, pod, stalk, outer husk, and surrounding pulp or other non-seed plant material. The seeds are preferably also biologically stable to the extent that the treatment would cause no biological damage to the seeds. In one embodiment, for example, the treatment can be applied to seeds that have been harvested, cleaned and dried to a specific moisture content. In an alternative embodiment, the seeds can be dried and then primed with water and/or another material and then re-dried before, during or after treatment with the natamycin producing bacterial strain. The natamycin producing bacterial strain is applied to the seed in an amount effective for controlling fungal diseases. The strain is effective when delivered at a concentration of 10³-10¹¹ colony forming units (cfu) per gram. For application on seeds from 1 to 1,000 g per 100 kg of seed can be used.

“Seed” as used herein means any resting stage of a plant that is physically detached from the vegetative stage of a plant. The term “resting” refers to a state wherein the plant retains viability, within reasonable limits, in spite of the absence of light, water and/or nutrients essential for the vegetative (i.e. non-seed) state. Seeds may be stored for prolonged periods of time and can be used to re-grow another plant individual of the same species. In particular, the term “seed” refers to true seeds, but does not embraces plant propagules such as suckers, corms, bulbs, fruit, tubers, grains, cuttings and cut shoots. In other words, seeds are a ripened ovule of gymnosperms and angiosperm which develops following fertilization and contains an embryo surrounded by a protective cover. Alternatively, artificial seeds do not need fertilization. Other food reserve storing tissues such as e.g. endosperm may be present in mature seeds. “Seed” as used herein also includes transgenic seeds, i.e. seeds of a transgenic plant. As used herein “transgenic plant” means a plant or progeny thereof derived from a transformed plant cell or protoplast, wherein the plant DNA contains an introduced exogenous DNA molecule not originally present in a native, non-transgenic plant of the same strain.

The natamycin producing bacterial strain can be used to control fungal plant pathogens on seeds of different types of plants including, but not limited to, corn, maize, triticale, peanut, flax, canola, rape, poppy, olive, coconut, grasses, soy, cotton, beet, (e.g. sugar beet and fodder beet), rice (any rice may be used, but is preferably selected from the group consisting of Oryza sativa sp. japonica, Oryza sativa sp. javanica, Oryza sativa sp. indica, and hybrids thereof), sorghum, millet, wheat, durum wheat, barley, oats, rye, sunflower, sugar cane, turf, pasture, alfalfa, or tobacco. It can also be used to control fungal plant pathogens on seeds of fruit plants including, but not limited to, rosaceous fruit, for example apples and pears; stone-fruits, for example peaches, nectarines, cherries, plums and apricots; citrus fruit, for example, oranges, grapefruit, limes, lemons, kumquats, mandarins and satsumas; nuts, for example pistachios, almonds, walnuts, coffee, cacao and pecan nuts; tropical fruits, for example, mango, papaya, pineapple, dates and bananas; and grapes; and vegetables including, but not limited to, leaf vegetables, for example endives, lambs lettuce, rucola, fennel, globe (head lettuce) and loose-leaf salad, chard, spinach and chicory; brassicas, for example, cauliflower, broccoli, Chinese cabbage, kale (winter kale or curly kale), kohlrabi, brussel sprouts, red cabbage, white cabbage and savoy; fruiting vegetables, for example, aubergines, cucumbers, paprika, marrow, tomatoes, courgettes, melons, watermelons, pumpkins and sweet corn; root vegetables, for example celeriac, turnip, carrots, swedes, radishes, horse radish, beetroot, salsify, celery; pulses, for example, peas and beans; and bulb vegetables, for example leeks, garlic and onions. The natamycin producing bacterial strain can also be used for the treatment of the seeds of ornamental plants, for example, pansy, impatiens, petunia, begonia, Lisianthus, sunflower, ageratum, chrysanthemum and geranium.

Some fungal plant pathogens that can be controlled according to the invention include, but are not limited to, species of the genera Acremonium, Alternaria, Aspergillus, Bipolaris, Botrytis, Bremia, Cladosporium, Diplodia, Erisiphe, Fusarium, Microdochium, Penicillium, Pestalotia, Phoma, Phycomycetes, Phytophthora, Plasmodiophora, Pyricularia, Pythium, Rhizoctonia, Sclerotinia, Septoria, Spatherotheca, Stachybotrys, Thielaviopsis, Trichoderma and Trichophyton.

The natamycin producing bacterial strain can be applied to a seed, a medium to be planted by the seed or both as such, i.e. without diluting or additional components present. However, the natamycin producing bacterial strain is typically applied in the form of a composition. The composition may be a ready-to-use composition or a concentrate which has to be diluted before use. Preferably, the composition comprises an agriculturally acceptable carrier. The term “agriculturally acceptable carrier” as used herein means an inert, solid or liquid, natural or synthetic, organic or inorganic substance which is mixed or combined with the active agent, e.g. the natamycin producing bacterial strain, for better applicability on seeds, media to be planted by seeds, and plants and parts thereof. It covers all carriers that are ordinarily used in (bio)fungicide formulation technology including, but not limited to, water, protective colloids, binders, salts, buffers, diluents, minerals, fillers, colorants, defoamers, adhesives, fixatives, tackifiers, resins, preservatives, stabilizers, fertilizers, anti-oxidation agents, gene activators, thickeners, plasticizers, siccatives, surfactants, dispersants, alcohols, complex formers, wetting agents, waxes, solvents, emulsifiers, mineral or vegetable oils, sequestering agents, and derivatives and/or mixtures thereof. The compositions may be mixed with one or more solid or liquid carriers and prepared by various means, e.g. by homogeneously mixing or blending the strain with suitable carriers using conventional formulation techniques. Depending on the type of composition that is prepared, further processing steps such as for instance granulation may be required.

In an embodiment the bacterial strain may be present at a level of 10³-10¹⁰ cfu/g carrier. In an embodiment the natamycin producing bacterial strain is present in 1% (w/w) to 99% (w/w) by weight of the entire composition, preferably 10% (w/w) to 75% (w/w). The present invention therefore also relates to a composition comprising a natamycin producing bacterial strain and an agriculturally acceptable carrier.

The natamycin producing bacterial strain can be applied simultaneously or in succession with other compounds to a seed, a medium to be planted by a seed or both. Examples of such compounds are fertilizers, growth regulators, (micro)nutrients, herbicides, rodenticides, miticides, bird repellents, attractants, insecticides, fungicides, acaricides, sterilants, bactericides, nematicides, mollusicides, or mixtures thereof. If desired, these other compounds may also comprise agriculturally acceptable carriers. If applied simultaneously, the natamycin producing bacterial strain and the other compound can be applied as one composition or can be applied as two or more separate compositions. If applied in succession, the natamycin producing bacterial strain can be applied first followed by the other compound or the other compound can be applied first followed by the natamycin producing bacterial strain. When the natamycin producing bacterial strain and the other compound are applied sequentially, the time between both applications may vary from e.g. 10 minutes to 100 days.

The natamycin producing bacterial strain and the other compound can be present in a kit of parts. The two or more components of the kit can be packaged separately. As such, kits include one or more separate containers such as vials, cans, bottles, pouches, bags or canisters, each container containing a separate component for an agrochemical composition.

In a further aspect the invention is concerned with a seed comprising at least one natamycin producing strain or a composition according to the present invention. In a specific embodiment the seed is coated with the at least one natamycin producing strain or the composition according to the present invention. In yet another aspect the present invention pertains to a medium to be planted by a seed, said medium comprising a composition according to the present invention.

The present invention also encompasses a method for preparing a coated seed according to the present invention, the method comprising the steps of (a) providing a seed, and (b) adding a coating comprising at least one natamycin producing bacterial strain or a composition according to the present invention to the seed.

The seeds can be contacted with the natamycin producing strain or the composition according to the present invention using all suitable seed treatment and especially seed dressing techniques known in the art, such as seed coating (e.g. seed pelleting, encrusting, film coating), seed dusting and seed imbibition (e.g. seed soaking, priming). Here, “seed treatment” refers to all methods that bring seeds and the natamycin producing strain or the composition according to the present invention into contact with each other, and “seed dressing” refers to methods of seed treatment which provide the seeds with an amount of the natamycin producing strain or the composition according to the present invention, i.e. which generate a seed comprising the natamycin producing strain or the composition according to the present invention. In principle, the treatment can be applied to the seeds at any time from the harvest of the seeds to the sowing of the seeds. The seeds can be treated immediately before, or during, the planting of the seed. However, the treatment may also be carried out several weeks or months before planting the seed, for example in the form of a seed dressing treatment. The treatment can be applied to unsown seeds. As used herein, the term “unsown seeds” is meant to include seeds at any period from the harvest of the seeds to the sowing of the seeds in the ground for the purpose of germination and growth of a plant. By applying the treatment to the seeds prior to the sowing of the seeds the operation is simplified. In this manner, seeds can be treated, for example, at a central location and then dispersed for planting. This permits the person who plants the seeds to avoid the handling and use of the natamycin producing strain or the composition according to the present invention and to merely handle and plant the treated seeds in a manner that is conventional for regular untreated seeds, which reduces human exposure.

Usually, a device which is suitable for seed treatment, for example a mixer for solid or solid/liquid components, is employed until the natamycin producing strain or the composition according to the present invention is distributed uniformly onto the seeds. The natamycin producing strain or the composition according to the present invention can be applied to seeds by any standard seed treatment methodology, including, but not limited to, mixing in a container (e.g. bottle, bag, tumbler, rotary coater, fluidized bed or sprayer), mechanical application, tumbling, spraying, and immersion. If appropriate, this is followed by drying of the seeds. Spray seed treatment is a method usually used for treating large volume of rice seeds. For this purpose, a solution obtained by dilution of a composition (e.g. a FS, LS, DS, WS, SS and ES) is sprayed continuously on seeds in a spray chamber and then dried at elevated temperature (e.g. 25 to 40° C.) in a drying chamber.

In another embodiment the seeds can be subjected to coating or imbibition (e.g. soaking). “Coating” denotes any process that endows the outer surfaces of the seeds partially or completely with a layer or layers of non-plant material. Coating is most commonly used for broad acre crops like rice and also vegetable seeds. According to this method the seeds are cleaned and afterwards coated with a diluted formulation by using e.g. a rotating pot-mixer for about several minutes and followed by reversible rotation. Afterwards, the seeds are dried.

“Imbibition” refers to any process that results in penetration of the natamycin producing strain or the composition according to the present invention into the germinable parts of the seed and/or its natural sheath, (inner) husk, hull, shell, pod and/or integument. According to the soaking method, the seeds are cleaned and packed in a bag that is sunk into the equivalent volume of solution with seed volume, wherein the solution normally is obtained by the dilution of a formulation such as FS, LS, DS, WS, SS and ES. Afterwards, the seed are dried. Soaking is most commonly applied for rice seed.

The invention also relates to a treatment of seeds which comprises providing seeds with a coating that comprises a natamycin producing strain or the composition according to the present invention and to a treatment of seeds which comprises imbibition of the seeds with a natamycin producing strain or the composition according to the present invention. Coating can also comprise spraying a natamycin producing strain or the composition according to the present invention onto the seeds, while agitating the seeds in an appropriate piece of equipment such as a tumbler or a pan granulator. Coating can also be carried out by moistening the external surface of the seeds and applying the natamycin producing strain or the composition according to the present invention to the moistened seeds and drying the obtained seeds. The seeds can be moistened, for example, by spraying with water or an aqueous solution. If the seeds are sensitive to swelling in water, they can be moistened with an aqueous solution containing an anti-swelling agent.

Coating may be applied to the seeds using conventional coating techniques and machines, such as fluidized bed techniques, the roller mill method, rotostatic seed treaters, and drum coaters. Other methods such as the spouted beds technique may also be useful. The seeds may be pre-sized before coating. After coating, the seeds are typically dried and then transferred to a sizing machine for sizing. Drying can be carried out by natural ventilation, but also in accordance with any technique which is in itself known, such as passing an optionally heated, forced stream of air over the seeds, which can be arranged, for this purpose, in apparatuses such as sieves.

When coating seeds on a large scale (for example a commercial scale), seeds may be introduced into treatment equipment (such as a tumbler, a drum, a plate, a mixer or a pan granulator) either by weight or by flow rate. The amount of the natamycin producing strain or the composition according to the present invention that is introduced into the treatment equipment can vary depending on the seed weight to be coated, surface area of the seeds, the concentration of the natamycin producing strain or the composition according to the present invention, the desired concentration on the finished seeds, and the like. The natamycin producing strain or the composition according to the present invention can be applied to the seeds by a variety of means, for example by a spray nozzle or revolving disc. The amount of the natamycin producing strain or the composition according to the present invention is typically determined by the required rate of the natamycin producing strain or the composition according to the present invention necessary for efficacy. As the seeds falls into the treatment equipment, the seeds can be treated (for example by misting or spraying with the natamycin producing strain or the composition according to the present invention) and passed through the treatment equipment under continual movement/tumbling where it can be coated evenly and dried before storage or use. In another embodiment, a known weight of seeds can be introduced into the treatment equipment. A known volume of the natamycin producing strain or the composition according to the present invention can be introduced into the treatment equipment at a rate that allows the natamycin producing strain or the composition according to the present invention to be applied evenly over the seeds. Powder for the encrusting can be added manually or through an automated powder feeder. During the application, the seeds can be mixed, for example by spinning or tumbling. The seeds can optionally be dried or partially dried during the tumbling operation. After complete coating or encrusting, the treated seeds can be removed to an area for further drying or additional processing, use, or storage. In still another embodiment, seeds can be coated in laboratory size commercial treatment equipment such as a tumbler, a mixer, or a pan granulator by introducing a known weight of seeds in the treatment equipment, adding the desired amount of the natamycin producing strain or the composition according to the present invention, tumbling or spinning the seeds and placing them on a tray to thoroughly dry. In another embodiment, seeds can also be coated by placing the known amount of seeds into a narrow neck bottle or receptacle with a lid. While tumbling, the desired amount of the natamycin producing strain or the composition according to the present invention can be added to the receptacle. The seeds are tumbled until they are coated, encrusted or pelleted with the natamycin producing strain or the composition according to the present invention. After coating, encrusting or pelleting, the seeds can optionally be dried, for example on a tray. If necessary, drying can be done by conventional methods. For example, a desiccant or mild heat (such as below about 40° C.) may be employed to produce a dry coating or encrusting.

Alternatively, coating may also be done by applying a sticking agent as an adhesive film over the seeds so that the natamycin producing strain or the composition according to the present invention in the form of a powder can be bonded to the seeds to form a coating, encrusting or pellet. For example, a quantity of seeds can be mixed with a sticking agent, and optionally agitated to encourage uniform coating of the seeds with the sticking agent. In the second step, the seed coated with the sticking agent can then be mixed with the powdered mixture of the natamycin producing strain or the composition according to the present invention. The dry formulation of the natamycin producing strain or the composition according to the present invention may contain other components. The mixture of seeds and the natamycin producing strain or the composition according to the present invention can be agitated, for example by tumbling, to encourage contact of the sticking agent with the powdered material, thereby causing the powdered material to stick to the seeds.

The composition that is used to treat the seeds in the present invention can be in the form of a soluble concentrate (SL, LS), a dispersible concentrate (DC), an emulsifiable concentrate (EC), a suspension (SC, OD, FS), an emulsion (EW, EO, ES), a slurry of particles in an aqueous medium (e.g. water), a paste, a water-dispersible or water-soluble powder (WP, SP, SS, WS), a pastille, a water-dispersible or water-soluble granule (WG, SG), a dry granule (GR, FG, GG, MG), a gel formulation (GF), a dustable powder (DP, DS), to name just a few. Water-soluble concentrates (LS), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of seeds. These compositions can be applied to seeds, diluted or undiluted.

In another aspect the present invention is concerned with a method for growing a plant, said method comprising the steps of (a) applying at least one natamycin producing bacterial strain to a seed, a medium to be planted by the seed or both, and (b) allowing a plant to grow from the seed. The seeds can be sowed manually or mechanically in the medium. The plant can be cultivated and brought up according to a usual manner. Obviously, a sufficient amount of water and nutrients needs to be added to achieve growth of the plant. Of course, a composition according to the present invention can also be used instead of a natamycin producing bacterial strain.

In yet another aspect the present invention is concerned with a method for producing a crop, said method comprising the steps of (a) applying at least one natamycin producing bacterial strain to a seed, a medium to be planted by the seed or both, (b) planting the seed in the medium, (c) growing a plant from the seed to yield a crop, and (d) harvesting the crop. The plant can be grown and the crop can be harvested according to methods known in the art. Of course, a composition according to the present invention can also be used instead of a natamycin producing bacterial strain.

The present invention is also concerned with the use of a natamycin producing bacterial strain as a biofungicide. Of course, a composition according to the present invention can also be used as a biofungicide. In addition, the current invention is concerned with the use of a natamycin producing bacterial strain as a plant growth enhancer and/or crop yield enhancer. Of course, a composition according to the present invention can also be used as a plant growth enhancer and/or crop yield enhancer.

### EXAMPLES

### Example 1

### Selection of Natamycin Producing Streptomyces natalensis Strains

The following eight natamycin producing Streptomyces natalensis strains were selected from an internal culture collection and tested for their antifungal activity in an in vitro experiment: DS10599, DS73309, DS10601, DS73871, DS73870, DS73311, DS73352 and DS73312.

Three fungal plant pathogens were tested against the selected S. natalensis strains: Fusarium oxysporum f.sp. lycopersici (CBS414.90), Colletotrichum gloeosporioides (CBS272.51) and Alternaria alternata (CBS103.33). Fusarium oxysporum f.sp. lycopersici is a soil borne fungus causing yield loss in e.g. tomato crops (Fusarium Wilt). Colletotrichum gloeosporioides causes e.g. anthracnose, a plant disease recognizable by dark brown lesions on leaves and fruits. Alternaria alternata is a worldwide occurring saprophyte that can cause phytopathogenic reactions in economically important host plants. The selected S. natalensis strains were tested against these fungal plant pathogens as described below.

Frozen vials (glycerol stocks) or freeze dried tubes from the selected S. natalensis strains were transferred to 100 ml baffled Erlenmeyer flasks containing 20 ml of Yeast Malt Extract broth (YME). Freeze dried tubes were resuspended in physiological saline and stored 1 hour at room temperature before they were transferred to the medium. The Erlenmeyer flasks were incubated in an incubator shaker for 3 days at 28° C. and 180 rpm.

For each strain, 200 μl of liquid media was transferred to YME agar plates (90 mm petridishes containing 20 ml of media) and dispersed with the use of a sterile spreader onto the surface of the media). Subsequently, the agar plates were incubated for 4 days at 28° C. to enhance full colony coverage of the plate surface.

The selected fungi were plated directly from a glycerol stock (200 μl) to YME agar and subsequently incubated for 4 days at 28° C.

The bio-assay was done as follows. Overgrown Streptomyces and fungi plates made as described above were used to produce agar plugs. The plugs were made by cutting out the agar by using a sterile cork-borer (11 mm diameter) and subsequently removing it by a pre-sterilized spatula. Freshly produced non-inoculated YME agar plates were marked with a line on the back of the petridish. This line with a fixed length of 4 cm was placed in the middle of the petridish. Subsequently, a Streptomyces inoculated agar plug was transferred to the fresh YME agar plate at the left end of the line. The above-described “plug transfer” step was repeated for the respective fungi. The respective fungi plugs were placed at the right end of the line on the same YME agar plate. Each Streptomyces strain was challenged in triplicate against each fungus. For each tested fungus, a control sample was taken (in triplicate) by using a non-inoculated agar plug that was placed on the left side of the petridish. Next, the plates were placed with the plugs on top in an incubator. Subsequently, the plates were stored at 28° C. for 7 days. After 7 days the radius of the fungal colony was measured in the direction of the opposite agar plug (Streptomyces sample). This step was repeated for the control sample. The inhibition zone (in percentage) was calculated by using the following formula:

100%*(r₀−r₁)/r₀

wherein r₀ is the radius (in mm, corrected for the plug radius) of the fungal colony from the control sample and wherein r₁ is the radius (in mm, corrected for the plug radius) of the fungal colony from the Streptomyces inhibited sample.

The results demonstrate that the fungal growth towards the natamycin producing S. natalensis strains was significantly inhibited. All strains outperformed the control sample without S. natalensis and the average inhibition varied from 53% to 66% depending on the tested strains (see Table 1). The results clearly demonstrate that S. natalensis strains have the potential to inhibit different species of fungal plant pathogens.

S. natalensis with the internal coding DS73870 and DS73871 were selected for further research. The strains were deposited under the terms of the Budapest Treaty with the Centraal Bureau voor Schimmelcultures (CBS), Utrecht, Netherlands, on May 20, 2014. S. natalensis strain DS73870 has been deposited as strain CBS 137965. S. natalensis strain DS73871 has been deposited as strain CBS 137966.

### Example 2

### Antifungal Activity of Natamycin Producing Streptomyces Strains

The following natamycin producing Streptomyces strains were tested for their antifungal activity in an in vitro experiment: Streptomyces natalensis ATCC-27448 (type strain), Streptomyces natalensis DS73871, Streptomyces natalensis DS73870 and Streptomyces chattanoogensis ATCC-19673.

Five fungal plant pathogens were tested against the selected Streptomyces strains: Fusarium oxysporum f.sp. lycopersici (CBS414.90), Colletotrichum gloeosporioides (CBS272.51), Alternaria alternata (CBS103.33), Aspergillus niger (ATCC16404) and Botrytis cinerea (CBS156.71). Aspergillus niger, also known as the black mould, is one of the most common Aspergillus species. This ubiquitous soil inhabitant is responsible for serious losses in different types of crops, such as: onions (black rot), grapes (fruit rot) and peanuts (crown rot). Botrytis cinerea is the causing agent of grey mould disease. This disease is recorded in a wide range of crops and has a high economic impact. For plant diseases related to Fusarium oxysporum f.sp. lycopersici, Colletotrichum gloeosporioides and Alternaria alternata, see Example 1. The selected S. natalensis strains were tested against these fungal plant pathogens as described below.

Frozen vials (glycerol stocks) from the selected S. natalensis strains were transferred to 100 ml baffled Erlenmeyer flasks containing 20 ml of Yeast Malt Extract broth (YME). The Erlenmeyer flasks were incubated in an incubator shaker for 3 days at 28° C. and 180 rpm.

For each strain, 200 μl of liquid media was transferred to YME agar plates and incubated for 4 days at 28° C. to enhance full colony coverage of the plate surface.

Botrytis cinerea was plated directly from glycerol stock (100 μl) to YME agar and subsequently incubated for 9 days at 28° C. All other selected fungi were plated directly from a glycerol stock (200 μl) to YME agar and subsequently incubated for 4 days at 28° C.

The bio-assay was done according to the procedure described in Example 1, with the alteration that all variables were tested in five-fold. The plates were stored at 28° C. for 7 days or 11 days, depending on the fungal colony growth of the control samples. After incubation, the radius of the fungal colony was measured according to the method described in Example 1.

The results demonstrate that the fungal growth towards the natamycin producing strains (Streptomyces natalensis & Streptomyces chattanoogensis) was inhibited in all tested samples compared to the control samples. The average inhibition varied from 2% to 78% depending on the tested strains (see Table 2). Therefore, these results clearly demonstrate that natamycin producing Streptomyces strains have the potential to inhibit different species of fungal plant pathogens.

The S. natalensis strains showed a higher reduction in the development of the fungal radius compared to the S. chattanoogensis. Furthermore, the S. natalensis strains DS73870 and DS73871 clearly outperformed the S. natalensis ATCC-27448 strain (=type strain). Depending on the tested fungal strains, the average inhibition of S. natalensis ATCC-27448 varied between 26% and 53%, whereas the average inhibition of S. natalensis DS73870 and DS73871 varied between 59% and 78% (see Table 2).

### Example 3

### Antifungal Activity of Natamycin Producing Streptomyces natalensis Strains DS73871 & DS73870 Against Verticillium albo-atrum

In another experiment, the natamycin producing Streptomyces natalensis DS73871 and Streptomyces natalensis DS73870 were tested for their antifungal activity against Verticillium albo-atrum (CBS321.91).

Verticillium albo-atrum is associated with Verticillium wilt. This soil borne fungus can cause serious harvest losses on a wide variety of crops, mainly in the cooler climate regions.

The experiment was done according to the method described in Example 1, with the proviso that all variables were tested in five-fold. For the production of fungal plugs, Verticillium albo-atrum (CBS321.91) was plated directly from a glycerol stock (200 μl) to YME agar and subsequently incubated for 4 days at 28° C.

The fungal radius of Verticillium albo-atrum towards the natamycin producing Streptomyces natalensis strains DS73871 and DS73870 was reduced by respectively 44% and 45% at day 11. After 25 days the inhibition zone was even further reduced to 76% and 71% for strains DS73871 and DS73870, respectively (see Table 3).

These results clearly demonstrate that S. natalensis DS73870 and DS73871 have the ability to inhibit Verticillium albo-atrum.

### Example 4

### Antifungal Activity of Natamycin Producing Streptomyces natalensis DS73871 and DS73870 Against Cercospora zeae-maydis

In another experiment, the natamycin producing Streptomyces natalensis strains DS73871 and DS73870 were tested for their antifungal activity against Cercospora zeae-maydis (CBS117757). Cercospora zeae-maydis causes “Grey leaf spot”, one of the most important foliar diseases on maize.

The experiment was done according to the method described in Example 1, with the only exception that the petridishes for “bioassay” (containing both bacterial and mould plugs) were stored for 28 days at 28° C. instead of 7 days.

The results (see Table 4) clearly demonstrate the inhibitory effect of S. natalensis strains DS73870 and DS73871 on the growth of Cercospora zeae-maydis. The radius of the fungal colony was decreased by 84% and 63% towards the bacterial strain for S. natalensis DS73871 and S. natalensis DS73870, respectively.

### Example 5

### Antifungal Activity of Natamycin Producing Streptomyces natalensis DS73871 & DS73870 Compared to Other Streptomyces sp. Against Colletotrichum gloeosporioides

This example describes the comparison of antifungal activity of natamycin producing strains Streptomyces natalensis DS73871 & DS73870 and several non-natamycin producing Streptomyces sp. (S. griseus, S. griseoviridis and S. rochei) against the fungal plant pathogen Colletotrichum gloeosporioides. The analysed non-natamycin producing strains were requested from the following public depositories: S. griseus (NRRLB1354), S. griseoviridis (NRRL2427) and S. rochei (CBS939.68).

The experiment was done according to the method described in Example 1 with the proviso that all variables were tested in five-fold and the pre-incubation time (culturing broth) was enhanced from 3 days to 4 to allow full growth of all strains. The fungal inhibition on the colony radius of Colletotrichum gloeosporioides (CBS272.51) was determined after 6 days of incubation at 28° C.

The results can be found in Table 5. The fungal radius of C. gloeosporioides was clearly reduced towards the opposing Streptomyces species in all samples compared to the control (no Streptomyces sp.). Furthermore, both Streptomyces natalensis DS73871 and DS73870 showed a stronger inhibitory effect (respectively 56% and 54%) compared to the non-natamycin producing Streptomyces species (between 7% and 33%).

### Example 6

### Antifungal Activity of Natamycin Producing Streptomyces natalensis DS73871 & DS73870 Compared to Other Streptomyces sp. Against Fusarium oxysporum f.Sp. lycopersici

In another experiment, the natamycin producing strains Streptomyces natalensis DS73871 & DS73870 were compared to the non-natamycin producing Streptomyces species: S. noursei and S. griseus for their antifungal activity against Fusarium oxysporum f.sp. lycopersici.

All three selected Streptomyces species are well described in literature for their ability to produce antifungal components. The analysed non-natamycin producing strains were requested from the following public depositories: Streptomyces noursei (CBS240.57) and S. griseus (NRRLB1354).

The experiment was done according to the method described in Example 1 with the proviso that all variables were tested in five-fold and the pre-incubation time (culturing broth) was enhanced from 3 days to 4 to allow full growth of all strains. The fungal inhibition of the Fusarium oxysporum f.sp. lycopersici (CBS414.90) colony radius was determined after 7 days of incubation at 28° C.

The colony growth of Fusarium oxysporum f.sp. lycopersici (CBS414.90) can be found in Table 6. The average inhibition zone was clearly reduced when challenged against Streptomyces species (between 11% and 60%). However the fungal inhibition of the natamycin producing Streptomyces species (60% and 54% for DS73870 and DS73871, respectively) was clearly stronger compared to the non-natamycin producing Streptomyces species (11% and 32% for S. griseus and S. noursei, respectively).

### Example 7

### Antifungal Activity of Natamycin Producing Streptomyces natalensis ATCC-27448 Compared to Pure Natamycin Against Colletotrichum gloeosporioides

In another experiment, the natamycin producing strain Streptomyces natalensis ATCC-27448 was cultured on YME agar plates to determine the natamycin concentration in the agar media. In a next step, the bioactivity of the Streptomyces natalensis strain was compared to a concentration range of pure natamycin (dissolved in methanol) against Colletotrichum gloeosporioides. This experiment was conducted following the protocol described below.

A frozen vial containing Streptomyces natalensis ATCC-27448 culture media was transferred to a 100 ml baffled Erlenmeyer flask containing 20 ml of Yeast Malt Extract broth (YME). The Erlenmeyer flask was incubated in an incubator shaker for 4 days at 28° C. and 180 rpm. 200 μl of the full grown culture broth was transferred (in duplo) to 90 mm petridishes containing exactly 20 ml of YME agar (YMEA). Subsequently, the inoculum was dispersed with the use of a sterile spreader onto the surface of the media. The plates were incubated for 4 days at 28° C. to enhance full colony coverage. After incubation the plates were freeze-dried (Alpha 2-4 LD Freeze dryer, Christ). The freeze-dried content of each agar plate was transferred to a volumetric flask and filled with pre-heated MilliQ (50° C.) to a final volume of 500 ml. This solution was stirred for approximately 30 minutes, centrifuged (8 minutes, 21,000 rcf) and the supernatant was subsequently tested for its natamycin concentration. The natamycin concentration was determined by using a well-known literature based method (HPLC-UV) and calculated back to the average concentration in the media plate.

In a next step, the full grown culture of Streptomyces natalensis ATCC-27448 was reproduced on YMEA (20 ml media in each 90 mm petridish), using the protocol described above. This culture was used for a bio-assay against Colletotrichum gloeosporioides (CBS272.51) using the bio-assay as described in Example 1. Next to the Streptomyces natalensis ATCC-27448 inoculated samples, control samples were taken by using a non-inoculated agar plug.

In parallel, YMEA plates were produced containing different concentrations of pure natamycin. Therefore, natamycin stock solutions were prepared by dissolving natamycin (Analytical grade, DSM Food Specialties, Delft, The Netherlands) into methanol (Merck, gradient grade for liquid chromatography, 99.9%). Subsequently, the natamycin stock solutions were added to liquid YME agar (45° C., corrected for the addition of methanol by lowering the water content) in a 1:19 ratio and mixed thoroughly through the media. The final natamycin concentrations in the agar were respectively: 500, 375, 250, 175, 100, 75, 50, 25, 10 and 0 ppm natamycin. The 0 ppm natamycin YMEA plates contained 5% (w/w) methanol only. The liquid YMEA was transferred to petridishes (20 ml media in each 90 mm petridish, done in threefold). After solidification, the YMEA plates were used for the bio-assay method against Colletotrichum gloeosporioides (CBS272.51) as described in Example 1. All samples were processed within the same day.

After 7 days of incubation at 28° C. the fungal radius and inhibition zone for Colletotrichum gloeosporioides (CBS272.51) were determined (see method described in Example 1).

The average concentration of natamycin that is produced by Streptomyces natalensis ATCC-27448 during pre-incubation in the agar media, was measured to be less than 10 ppm (however, not 0 ppm). By dissolving 10 ppm pure natamycin directly into an agar plug, the inhibition zone of Colletotrichum gloeosporioides was not as high compared to the inhibition zone produced by the Streptomyces natalensis ATCC-27448 agar plug (see Table 7). Similar inhibition zones were matched at a much higher concentration rate (approximately 375 ppm).

### Example 8

### Effect of Seed Treatment with Streptomyces natalensis DS73870 and DS73871 on Lettuce Grown in Soil Artificially Infested with Rhizoctonia solani

Rhizoctonia solani (CBS 323.84) obtained from a 9 day old MEA media agar plate (incubation temperature 24° C.) was dissolved in water. The fungal inoculum (50 ml/I soil) was mixed thoroughly through soil (90% peat, 10% sand). Seeding trays were filled with the inoculated soil 2 days prior to seeding. Each tray contained approximately 7.5 liter of soil).

Frozen vials (glycerol stocks) from Streptomyces natalensis strains DS73870 and DS73871 were transferred to 100 ml baffled Erlenmeyer flasks containing 20 ml of Yeast Malt Extract broth (YME). The Erlenmeyer flasks were incubated in an incubator shaker (G24 Environmental Incubator Shaker, New Brunswick Scientific Co.) for 4 days at 28° C. and 180 rpm. Subsequently, for each strain 2 ml of cultured broth was transferred to 500 ml baffled Erlenmeyer flasks containing 200 ml of YME broth. The media were incubated for another 3 days at 28° C. and 180 rpm (orbital Incubator Inr200-010V, Gallenkamp). The measured bacterial load of the media was 6.3 log CFU/ml (DS73870) and 7.9 log CFU/ml (DS73871). Finally, the samples were shipped, under cooled conditions, to a lab facility for a challenge study under greenhouse conditions and processed within 24 hours.

At the greenhouse lab facility, the media containing S. natalensis DS73870 and DS73871 were 4-fold diluted in water. Then, the required quantities of lettuce seeds (variety: Weston) were soaked in the diluted S. natalensis inoculum (1 part seeds and 19 parts diluted transfer medium) and continuously shaken for 1 hour (at 120 rpm, room temperature). After soaking, the seeds were air-dried (1 hour) and planted directly afterwards into the soil at a depth of approximately 1 cm. In addition to the S. natalensis treated samples, non-inoculated control seeds were treated under the same conditions, with the exception that they were soaked in sterile (non-inoculated) transfer medium.

Each treatment was tested in 4 replicates. Each replicate consisted of 1 seeding tray containing 96 seeds. Trials were conducted according to EPPO guidelines PP 1/148(2), PP 1/135(3) and PP 1/152(4). The treatments were maintained under controlled greenhouse conditions and watered at set time intervals. The seeds, seedlings or plants were assessed weekly on: germination rate, crop vigour and disease severity for a maximum of 1 month after seeding.

The results are summarized in Table 8 (germination rate and crop vigour) and Table 9 (plant disease severity). The negative impact of Rhizoctonia solani on the plant vitality was extremely high, however this effect was reduced by the activity of S. natalensis strains added to the lettuce seeds.

The results in Table 8 shows that the number of unaffected plants was increased when seeds were treated with the Streptomyces natalensis DS73870 or DS73871 strains compared to treatment with sterile medium (control). Furthermore, the amount of lettuce plants that were not germinated or died after germination (classified as not present) was exceedingly higher for the control samples compared to the S. natalensis treated samples. Also the “Crop vigour” of the plants was clearly increased for the plants that were seed treated with S. natalensis DS73870 or DS73871. Moreover, the plant disease severity was reduced for the S. natalensis DS73870 or DS73871 seed treated plants compared to the control (see Table 9).

In conclusion, by applying a natamycin producing S. natalensis strain to a seed, both plant growth and vitality could be enhanced of crops that are affected by fungal plant pathogens.

TABLE 1
Fungal radius of different plant pathogens tested against
several Streptomyces natalensis strains on YME agar
plates after 7 days of incubation at 28° C.

| | Tested | Fungal | Average |
|---|---|---|---|
| Tested | S. natalensis | radius | inhibition |
| fungus | strain | (in mm) | zone (in %) |
| Fusarium | Control (no | 28.7 | 0 |
| oxysporum | S. natalensis | | |
| f.sp. lycopersici | strain) | | |
| (CBS414.90) | DS10599 | 13.3 | 53 |
| | DS10601 | 12.0 | 58 |
| | DS73871 | 11.3 | 60 |
| | DS73309 | 12.7 | 56 |
| | DS73311 | 13.3 | 53 |
| | DS73312 | 12.7 | 56 |
| | DS73870 | 11.3 | 60 |
| | DS73352 | 11.3 | 60 |
| Colletotrichum | Control (no | 39.3 | 0 |
| gloeosporioides | S. natalensis | | |
| (CBS272.51) | strain) | | |
| | DS10599 | 16.3 | 58 |
| | DS10601 | 15.7 | 60 |
| | DS73871 | 14.0 | 64 |
| | DS73309 | 16.0 | 59 |
| | DS73311 | 14.3 | 64 |
| | DS73312 | 15.0 | 62 |
| | DS73870 | 13.3 | 66 |
| | DS73352 | 13.7 | 65 |
| Alternaria | Control (no | 22.3 | 0 |
| alternata | S. natalensis | | |
| (CBS103.33) | strain) | | |
| | DS10599 | 9.3 | 58 |
| | DS10601 | 9.0 | 60 |
| | DS73871 | 8.3 | 63 |
| | DS73309 | 8.7 | 61 |
| | DS73311 | 8.0 | 64 |
| | DS73312 | 8.3 | 63 |
| | DS73870 | 8.7 | 61 |
| | DS73352 | 8.3 | 63 |

TABLE 2
Fungal radius of different plant pathogens tested against several
strains of natamycin producing Streptomyces species on
YME agar plates after 7 or 11 days of incubation at 28° C.

| | Days | Tested | Fungal | Average |
|---|---|---|---|---|
| Tested | of | Streptomyces | radius | inhibition |
| fungus | incubation | strain | (in mm) | zone (in %) |
| Fusarium | 7 | Control | 36.9 | 0 |
| oxysporum f.sp. | | (no Streptomyces | | |
| lycopersici | | strain) | | |
| (CBS414.90) | 7 | S. chattanoogensis | 33.9 | 8 |
| | | ATCC19673 | | |
| | 7 | S. natalensis | 27.5 | 26 |
| | | ATCC27448 | | |
| | 7 | S. natalensis | 14.8 | 60 |
| | | DS73871 | | |
| | 7 | S. natalensis | 14.0 | 62 |
| | | DS73870 | | |
| Colletotrichum | 7 | Control (no | 42.2 | 0 |
| gloeosporioides | | Streptomyces | | |
| (CBS272.51) | | strain) | | |
| | 7 | S. chattanoogensis | 35.5 | 16 |
| | | ATCC19673 | | |
| | 7 | S. natalensis | 30.2 | 28 |
| | | ATCC27448 | | |
| | 7 | S. natalensis | 16.6 | 61 |
| | | DS73871 | | |
| | 7 | S. natalensis | 17.4 | 59 |
| | | DS73870 | | |
| Alternaria | 11 | Control (no | 43.5 | 0 |
| alternata | | Streptomyces | | |
| (CBS103.33) | | strain) | | |
| | 11 | S. chattanoogensis | 38.3 | 12 |
| | | ATCC19673 | | |
| | 11 | S. natalensis | 20.6 | 53 |
| | | ATCC27448 | | |
| | 11 | S. natalensis | 9.9 | 77 |
| | | DS73871 | | |
| | 11 | S. natalensis | 9.8 | 78 |
| | | DS73870 | | |
| Aspergillus | 7 | Control (no | 43.4 | 0 |
| niger | | Streptomyces | | |
| (ATCC16404) | | strain) | | |
| | 7 | S. chattanoogensis | 42.5 | 2 |
| | | ATCC19673 | | |
| | 7 | S. natalensis | 28.2 | 35 |
| | | ATCC27448 | | |
| | 7 | S. natalensis | 14.8 | 66 |
| | | DS73871 | | |
| | 7 | S. natalensis | 15.7 | 64 |
| | | DS73870 | | |
| Botrytis | 11 | Control (no | 7.7 | 0 |
| cinerea | | Streptomyces | | |
| (CBS156.71) | | strain) | | |
| | 11 | S. chattanoogensis | 5.4 | 30 |
| | | ATCC19673 | | |
| | 11 | S. natalensis | 5.1 | 33 |
| | | ATCC27448 | | |
| | 11 | S. natalensis | 2.3 | 70 |
| | | DS73871 | | |
| | 11 | S. natalensis | 2.0 | 74 |
| | | DS73870 | | |

TABLE 3
Fungal radius of Verticillium albo-atrum (CBS321.91)
tested against Streptomyces natalensis DS73870 and
DS73871 on YME agar plates after 11 days
and 25 days of incubation at 28° C.

| | Days | Tested | Fungal | Average |
|---|---|---|---|---|
| Tested | of | S. natalensis | radius | inhibition |
| fungus | incubation | strain | (in mm) | zone (in %) |
| Verticillium | 11 | Control (no | 7.1 | 0 |
| albo-atrum | | S. natalensis | | |
| | | strain) | | |
| | 11 | S. natalensis | 4.0 | 44 |
| | | DS73871 | | |
| | 11 | S. natalensis | 3.9 | 45 |
| | | DS73870 | | |
| | 25 | Control (no | 17.5 | 0 |
| | | S. natalensis | | |
| | | strain) | | |
| | 25 | S. natalensis | 4.2 | 76 |
| | | DS73871 | | |
| | 25 | S. natalensis | 5.0 | 71 |
| | | DS73870 | | |

TABLE 4
Fungal radius of Cercospora zeae-maydis (CBS117757) tested
against Streptomyces natalensis DS73870 and DS73871 on
YME agar plates after 28 days of incubation at 28° C.

| | | Fungal | Average |
|---|---|---|---|
| Tested | Tested | radius | inhibition |
| fungus | S. natalensis strain | (in mm) | zone (in %) |
| Cercospora | Control (no S. natalensis strain) | 6.3 | 0 |
| zeae-maydis | S. natalensis DS73871 | 1.0 | 84 |
| | S. natalensis DS73870 | 2.3 | 63 |

TABLE 5
Fungal radius of Colletotrichum gloeosporioides
(CBS272.51) tested against several Streptomyces sp.
on YME agar plates after 6 days of incubation at 28° C.

| | Days | | | Average |
|---|---|---|---|---|
| | of | | Fungal | inhibition |
| Tested | incu- | Tested | radius | zone |
| fungus | bation | Streptomyces strain | (in mm) | (in %) |
| Colletotrichum | 6 | Control (no | 37.9 | 0 |
| gloeosporioides | | Streptomyces strain) | | |
| | 6 | S. natalensis DS73870 | 17.4 | 54 |
| | 6 | S. natalensis DS73871 | 16.7 | 56 |
| | 6 | S. griseus NRRLB1354 | 25.4 | 33 |
| | 6 | S. griseoviridis NRRL2427 | 35.1 | 7 |
| | 6 | S. rochei CBS939.68 | 34.2 | 10 |

TABLE 6
Fungal radius of Fusarium oxysporum f.sp. lycopersici
(CBS414.90) tested against several Streptomyces sp. on
YME agar plates after 7 days of incubation at 28° C.

| | Days of | | Fungal | Average |
|---|---|---|---|---|
| Tested | incu- | Tested | radius | inhibition |
| fungus | bation | Streptomyces strain | (in mm) | zone (in %) |
| Fusarium | 7 | Control (no | 37.0 | 0 |
| oxysporum | | Streptomyces strain) | | |
| f.sp. | 7 | S. natalensis DS73870 | 15.0 | 60 |
| lycopersici | 7 | S. natalensis DS73871 | 17.0 | 54 |
| | 7 | S. griseus NRRLB1354 | 33.1 | 11 |
| | 7 | S. noursei CBS240.57 | 25.1 | 32 |

TABLE 7
Agar plug bio-assay. Fungal radius of Colletotrichum
gloeosporioides (CBS272.51) tested against
S. natalensis ATCC27448 and different ratios
of pure natamycin dissolved in methanol (5% w/w).
Results produced on YME agar plates after 7 days
of incubation at 28° C.

| | | | | Average |
|---|---|---|---|---|
| | | | Fungal | inhibition |
| | | | radius | zone |
| Tested fungus | Plug content | | (in mm) | (in %) |
| Colletotrichum | Control (sterile plug) | | 46.3 | 0 |
| gloeosporioides | S. natalensis ATCC27448 | | 29.3 | 37 |
| | (containing <10 ppm | | | |
| | natamycin | | | |
| | derived from | | | |
| | pre-incubation) | | | |
| | 0 | ppm Natamycin* | 45.2 | 2 |
| | 10 | ppm Natamycin* | 44.3 | 4 |
| | 25 | ppm Natamycin* | 43.2 | 7 |
| | 50 | ppm Natamycin* | 39.3 | 15 |
| | 75 | ppm Natamycin* | 37.8 | 18 |
| | 100 | ppm Natamycin* | 36.7 | 21 |
| | 175 | ppm Natamycin* | 34.8 | 25 |
| | 250 | ppm Natamycin* | 33.2 | 28 |
| | 375 | ppm Natamycin* | 30.3 | 35 |
| | 500 | ppm Natamycin* | 27.3 | 41 |

*dissolved in YMEA containing 5% w/w methanol, given concentration is the concentration of the agar plug

TABLE 8
Effect of seed treatment with Streptomyces natalensis DS73870 and
DS73871 on the germination rate and crop vigour of lettuce grown in
soil artificially infested with Rhizoctonia solani.

| | | Germination rate (n = 96) | | | | Crop |
|---|---|---|---|---|---|---|
| Seed | Day of | Unaffected | Abnormal | Inhibited | Not | vigour |
| treatment | measurement* | growth | growth | growth | present** | (%) |
| control | 7 | 11.3 | 20.8 | 1.3 | 62.8 | 92.5 |
| (untreated) | | | | | | |
| S. natalensis | | 15.3 | 17.8 | 3.5 | 59.5 | 100.0 |
| DS73870 | | | | | | |
| S. natalensis | | 16.0 | 14.8 | 2.5 | 62.8 | 99.5 |
| DS73871 | | | | | | |
| control | 12 | 4.3 | 1.8 | 8.8 | 81.3 | 100.0 |
| (untreated) | | | | | | |
| S. natalensis | | 7.8 | 2.3 | 17.3 | 68.8 | 106.3 |
| DS73870 | | | | | | |
| S. natalensis | | 9.8 | 1.8 | 13.0 | 71.5 | 104.8 |
| DS73871 | | | | | | |
| control | 19 | 6.0 | 8.5 | 7.0 | 74.5 | 100.0 |
| (untreated) | | | | | | |
| S. natalensis | | 10.8 | 11.0 | 14.3 | 60.0 | 108.0 |
| DS73870 | | | | | | |
| S. natalensis | | 11.5 | 8.0 | 11.8 | 64.8 | 107.5 |
| DS73871 | | | | | | |
| control | 26 | 5.5 | 0.0 | 10.3 | 80.3 | 100.0 |
| (untreated) | | | | | | |
| S. natalensis | | 9.3 | 0.0 | 20.3 | 66.5 | 107.3 |
| DS73870 | | | | | | |
| S. natalensis | | 9.5 | 0.0 | 18.0 | 68.5 | 106.0 |
| DS73871 | | | | | | |
| control | 32 | 5.3 | 1.3 | 11.8 | 77.8 | 100.0 |
| (untreated) | | | | | | |
| S. natalensis | | 11.3 | 1.5 | 20.5 | 62.8 | 107.3 |
| DS73870 | | | | | | |
| S. natalensis | | 12.0 | 1.0 | 16.5 | 66.5 | 106.5 |
| DS73871 | | | | | | |

*measured from day of seeding (day 0)
**Not germinated or deceased after germination

TABLE 9
Effect of seed treatment with Streptomyces natalensis DS73870 and DS73871 on the plant
disease severity of Lettuce grown in soil artificially infested with Rhizoctonia solani.

| | | Plant disease severity (n = 96) | | | | |
|---|---|---|---|---|---|---|
| Seed | Day of | | | | | Not |
| treatment | measurement* | Healthy | Light | Moderate | Severe | present** |
| control | 7 | 12.5 | 20.8 | 0.0 | 0.0 | 62.8 |
| (untreated) | | | | | | |
| DS73870 | | 18.8 | 17.8 | 0.0 | 0.0 | 59.5 |
| DS73871 | | 18.5 | 14.8 | 0.0 | 0.0 | 62.8 |
| control | 12 | 1.5 | 0.0 | 0.8 | 12.5 | 81.3 |
| (untreated) | | | | | | |
| DS73870 | | 9.0 | 0.0 | 1.5 | 16.8 | 68.8 |
| DS73871 | | 8.5 | 0.0 | 0.8 | 15.3 | 71.5 |
| control | 19 | 13.3 | 1.0 | 1.8 | 5.5 | 74.5 |
| (untreated) | | | | | | |
| DS73870 | | 27.0 | 2.3 | 0.8 | 6.0 | 60.0 |
| DS73871 | | 24.0 | 1.3 | 1.5 | 4.5 | 64.8 |
| control | 26 | 11.0 | 0.0 | 0.0 | 4.8 | 80.3 |
| (untreated) | | | | | | |
| DS73870 | | 24.3 | 0.0 | 0.0 | 5.3 | 66.5 |
| DS73871 | | 21.8 | 0.0 | 0.3 | 5.5 | 68.5 |
| control | 32 | 14.5 | 2.3 | 0.3 | 1.3 | 77.8 |
| (untreated) | | | | | | |
| DS73870 | | 30.8 | 2.0 | 0.0 | 0.5 | 62.8 |
| DS73871 | | 23.5 | 4.5 | 0.3 | 1.3 | 66.5 |

*measured from day of seeding (day 0)
**Not germinated or deceased after germination

### REFERENCES

Chen G Q, Lu F P and Du L X (2008), Natamycin production by Streptomyces gilvosporeus based on statistical optimization. J. Agric. Food Chem. 56:5057-5061.
Farid M A, El-Enshasy H A, El-Diwany A I and El-Sayed, E A (2000), Optimization of the cultivation medium for natamycin production by Streptomyces natalensis. J. Basic Microbiol. 40: 157-166.
El-Enshasy H A, Farid M A and El-Sayed, E A (2000), Influence of inoculum type and cultivation conditions on natamycin production by Streptomyces natalensis. J. Basic Microbiol. 40: 333-342.
He Y L, Wu J G, Lu F P and Du L X (2002) Fed-batch fermentation to improve the yield of natamycin. Med. Biotechnol. 9:224-226.
Liang J G, Xu Z N, Liu T F, Lin H P and Cen P L (2008), Effects of cultivation conditions on the production of natamycin with Streptomyces gilvosporeus LK-196. Enzyme Microb. Technol. 42:145-150.
Martin J F and McDaniel L E (1977), Production of polyene macrolide antibiotics. Advances in Appl. Microbiol. 21:1-52.

1. A method for enhancing plant growth, crop yield or both, the method comprising applying at least one natamycin producing bacterial strain to a seed, a medium to be planted by the seed or both.

2. The method according to claim 1, wherein the strain is applied in the form of a composition comprising an agriculturally acceptable carrier.

3. The method according to claim 2, wherein the composition comprises 10³-10¹⁰ cfu/g carrier.

4. The method according to claim 1, wherein the natamycin producing bacterial strain is selected from the group consisting of a Streptomyces natalensis strain, a Streptomyces gilvosporeus strain, and a Streptomyces chattanoogensis strain.

5. A composition comprising a natamycin producing bacterial strain and an agriculturally acceptable carrier.

6. A seed comprising at least one natamycin producing bacterial strain or a composition according to claim 5.

7. The seed according to claim 6, wherein the seed is coated with the at least one natamycin producing bacterial strain or a composition comprising a natamycin producing bacterial strain and an agriculturally acceptable carrier.

8. A medium to be planted by a seed comprising a composition according to claim 5.

9. A method for preparing a coated seed according to claim 7, the method comprising:
a) providing a seed,
b) adding a coating comprising at least one natamycin producing bacterial strain or a composition comprising a natamycin producing bacterial strain and an agriculturally acceptable carrier to the seed.

10. A method for growing a plant, said method comprising:
a) applying at least one natamycin producing bacterial strain to a seed, a medium to be planted by the seed or both, and
b) allowing a plant to grow from the seed.

11. A method for producing a crop, said method comprising:
a) applying at least one natamycin producing bacterial strain to a seed, a medium to be planted by the seed or both,
b) planting the seed in the medium,
c) growing a plant from the seed to yield a crop, and
d) harvesting the crop.

12. A natamycin producing bacterial strain capable of being used as a biofungicide.

13. A natamycin producing bacterial strain capable of being used as a plant growth enhancer and/or crop yield enhancer.
